(19) United States
(12) Patent Application Publication
(10) Pub. No.: US 2010/0207573 A1
(43) Pub. Date: Aug. 19, 2010

(54) Thermoelectric feedback circuit

(76) Inventors: Anthony Mo, Mountain Lakes, NJ (US); Michael Palazzi, Mountain Lakes, NJ (US)

Correspondence Address: Gearhart Law LLC, 4 Ferndale Road, Chatham, NJ, 07928, US

(21) Appl. No.: 12/658,623

(22) Filed: Feb. 11, 2010

Related U.S. Application Data
(60) Provisional application No. 61/207,378, filed on Feb. 11, 2009.

(51) Int. Cl. F21S 9/02; F21S 9/04; F21V 29/00

(52) U.S. Cl. 320/101; 315/112

(57) ABSTRACT

An article of manufacture, comprising: an LED or other light source in thermal communication with a thermoelectric module; and a feedback circuit that directs current generated by the thermoelectric module to at least one device. This invention improves on prior art by recycling heat produced by the LED or other light source into electricity produced via the thermoelectric module to be used by the light source, a cooling device, battery charger for battery backup system, control or monitoring system, etc.

### CLAIM OF PRIORITY

This application claims the benefit of priority of U.S. Provisional Application No. 61/207,378 filed on Feb. 11, 2009, the contents of which are fully incorporated herein by reference.

### FIELD OF THE INVENTION

The invention relates the fields of lighting technology, waste heat recovery and the efficient use of electricity, in particular, the invention teaches a combination of a light source, a heat sink, a thermoelectric electric module and driver circuits.

### BACKGROUND OF THE INVENTION

A light source, such as a LED unit, is specified that combines a light producing module, a heat sink and a thermoelectric circuit. The thermoelectric circuit recovers some of the ejected heat from the light source and converts it into electricity. The electricity generated from ejected heat may be used to reduce the electricity demand for the unit and allowing for the use of a smaller heat sink, or may be used for powering low power consuming devices or circuits associated with the light source.

### DESCRIPTION OF RELATED ART

International Patent Application No. WO2007038156 teaches a method for manufacturing an LED lamp assembly includes anodizing at least a portion of a surface of an electrically and thermally conductive base, such as an aluminum or aluminum alloy base, so as to form an electrically insulating coating. The base may form a heat sink or be coupled to a heat sink. Circuit traces are formed on the anodized surface of the base, which include LED landings. LEDs are electrically and mechanically attached to the LED landing by means of conductive metallic solder such that heat generated from the LED is transferred efficiently through the solder and circuit traces LED landings to the base and heat sink through a metal-to-metal contact pathway.

International Patent Application No. WO2004038290 teaches an invention related to Light Emitting Diode (LED) based lamps utilizing thermoelectric modules improving the efficiency of the lamps. The invention provides in a first aspect a light illuminating device that comprises at least one light emitting diode (LED), at least one thermoelectric module (TEM) having a first surface which is thermally connected to the LED, a heat sink thermally connected to a second surface of the at least one TEM, a thermally insulating cover creating a chamber substantially insulating the LED from ambient air. The LED may be of any conventional type, the invention however is particularly useful for devices using hi-flux LEDs, including traffic lights, illuminated roadway and/or emergency signs, airport runway lights and such.

International Patent Application No. WO2003081127 teaches a cooled light emitting apparatus comprises a light source including a close packed array of light emitting diode devices (high intensity LEDs) and a cooling system for cooling the light source. The cooling system comprises a thermoelectric cooling device in the form of a Peltier device connected via a heat spreader to the light source and a heat exchange system for removing heat from the Peltier device. The heat exchange system uses liquid coolant (or refrigerant) to cool the Peltier device. By extracting heat from the LED array at a rate greater than 5 W cm⁻² it is possible to maintain the LED array at a temperature of less than −10 degrees Celsius, and thus emit light having an optical power density of greater than 1 Wcm⁻².

U.S. Pat. No. 7,348,604 teaches a light-emitting module according to the present invention comprises a heat dissipation element, a substrate for example a metal core printed circuit board (MCPCB), or FR4 board which is coupled to one or more light-emitting elements and provides a means for operative connection of the light-emitting elements to a source of power. The substrate is positioned such that it is thermally coupled to the heat dissipation element. The light-emitting module further comprises a housing element which matingly connects with the heat dissipation element, wherein the housing element may further comprise an optical element integrated therein for manipulation of the light generated by the one or more light-emitting elements.

U.S. Pat. No. 7,329,027 teaches an organic light-emitting diode lighting apparatus having an organic light-emitting diode lamp having a thermally conductive mounting member having a mounting surface on a first side and second light-emitting surface and a thin-film light-emitting structure adjacent the second light-emitting surface, the thin-film light-emitting structure comprising an anode, a light-emitting layer, and a cathode, and a thermally conductive mounting fixture having a thermally conductive mounting surface on which the thermally conductive mounting member is secured such that there is substantially continuous thermal contact across the mounting surface.

U.S. Pat. No. 7,288,796 teaches a light source that utilizes light emitting diodes that emit white light is disclosed. The diodes are mounted on an elongate member having at least two surfaces upon which the light emitting diodes are mounted. The elongate member is thermally conductive and is utilized to cool the light emitting diodes. In the illustrative embodiment, the elongate member is a tubular member through which a heat transfer medium flows. A cooling or fluid movement device coupled with the elongate thermally conductive member enhances cooling of the light emitting diodes.

U.S. Pat. No. 7,093,952 teaches an invention to provide a lighting apparatus that includes a simple and small moving mechanism capable of changing the light emanation direction and that has superior heat dissipation properties, the lighting apparatus includes a light-emitting unit, and a heat dissipation unit for dissipating heat generated by the light-emitting unit during light emission, wherein a heat transfer unit is connected between the light-emitting unit and the heat dissipation unit, and the light-emitting unit is in surface contact with the heat transfer unit and is connected with the heat transfer unit to be rotatable with one point or one line in the center.

US Patent Application No. 20060237730 teaches a Peltier effect cooling device is formed in combination with an electronic device to form a unique thermal and electrical relationship. An electronic device to be cooled is placed in a serial electrical relationship between at least two thermoelectric couples while simultaneously being in thermal contact with a cold side of the cooler arrangement. The same current which, produces the thermoelectric effect in the Peltier thermocouples, also drives the electronic device. A balanced effect results as a higher driving current through the electronic device to causes greater heating, it is offset by the added cooling due to a greater current in the thermocouples. In addition, a unique spatial arrangement provides improved heat distribution and transfer to a heat sink. Due to the unique shapes of Peltier elements, heat is pulled radially from a heat-generating source and distributed at a peripheral region. Shaped Peltier elements are tapered from a small cold area to a large hot area to further magnify the transfer of heat.

US Patent Application No. 20060198149 teaches an invention that relates to Light Emitting Diode (LED) based lamps utilizing thermoelectric modules improving the efficiency of the lamps. This invention provides in a first aspect a light illuminating device that comprises at least one light emitting diode (LED), at least one thermoelectric module (TEM) having a first surface which is thermally connected to the LED, a heat sink thermally connected to a second surface of the at least one TEM, a thermally insulating cover creating a chamber substantially insulating the LED from ambient air. The LED may be of any conventional type, the invention however is particularly useful for devices using hi-flux LEDs, including traffic lights, illuminated roadway and/or emergency signs, airport runway lights and such.

US Patent Application No. 2006015180 teaches Systems and methods for fabricating a light emitting diode include depositing one or more metal layers on a substrate; forming an n-gallium nitride (n-GaN) layer above the metal layer; and depositing a thermoelectric cooler in the metal layer to dissipate heat.

US Patent Application No. 20060128059 teaches an improved integrated circuit package for providing built-in heating or cooling to a semiconductor chip is provided. The improved integrated circuit package provides increased operational bandwidth between different circuit devices, e.g. logic and memory chips. The improved integrated circuit package does not require changes in current CMOS processing techniques. The structure includes the use of a silicon interposer. The silicon interposer can consist of recycled rejected wafers from the front-end semiconductor processing. Micro-machined vias are formed through the silicon interposer. The micro-machined vias include electrical contacts which couple various integrated circuit devices located on the opposing surfaces of the silicon interposer. The packaging includes a Peltier element.

US Patent Application No, 2006009264 teaches an organic light-emitting diode lighting apparatus having an organic light-emitting diode lamp having a thermally conductive mounting member having a mounting surface on a first side and second light-emitting surface and a thin-film light-emitting structure adjacent the second light-emitting surface, the thin-film light-emitting structure comprising an anode, a light-emitting layer, and a cathode, and a thermally conductive mounting fixture having a thermally conductive mounting surface on which the thermally conductive mounting member is secured such that there is substantially continuous thermal contact across the mounting surface.

US Patent Application No. 20060088271 teaches a thermoelectric cooler may be transiently operated in substantial synchronization with operation of an optoelectronic device to provide extremely high density and intensity spot cooling when and where desired. The invented techniques described and illustrated herein can permit high luminous flux and/or longer lifetimes for a class of emissive device configurations and/or uses that generate intense highly localized, but transient heat flux. For example, certain Light Emitting Diode (LED) applications, e.g., white LEDs for flash illumination, certain solid state laser configurations and other similar configurations and uses may benefit from the developed techniques. In addition, the invented techniques described and illustrated herein can be employed in sensor configurations to provide greater device sensitivity. For example, in photosensitive device applications, e.g., CCD/CMOS imagers, the invented techniques may be employed to provide greater photon sensitivity and lower dark currents.

US Patent No. 20050258438 teaches a light emitting apparatus includes one or more light emitting diode chips disposed on a chip support wall including printed circuitry connecting with the light emitting diode chips. A heat pipe has a sealed volume) defined by walls including the chip support wall and at least one additional wall The heat pipe further includes a heat transfer fluid disposed in the sealed volume.

US Patent Application No. 20050243539 teaches a cooled light emitting apparatus comprises a light source including a close packed array of light emitting diode device (high intensity LEDs) and a cooling system for cooling the light source. The cooling system comprises a thermoelectric cooling device in the form of a Peltier device connected via a heat spreader to the light source and a heat exchange system for removing heat from the Peltier device. The heat exchange system uses liquid coolant (or refrigerant) to cool the Peltier device. By extracting heat from the LED array at a rate greater than 5 W cm⁻² it is possible to maintain the LED array at a temperature of less than −10 degrees Celsius, and thus emit light having an optical power density of greater than 1 Wcm².

US Patent Application No. 20050047170 teaches an LED light source assembly, utilizing a standard electrical socket with an integrated heat sink and an adjustable secondary heat sink structure is described. The LED light source assembly places a LED light source at a similar relative position inside a lamp housing as a traditional incandescent light bulb, to take advantage of traditional reflector geometries. A heat sink is attached to an automobile electrical socket, having a standard shape for traditional incandescent lighting. A LED light source is installed on the heat sink, and receives electricity from the automobile via the electrical socket. A secondary LED heat sink, with a second LED light source, may optionally be affixed to one of several possible attachment points of the LED light source assembly. The addition of a secondary LED heat sink allows the number and position of LED light sources to be varied according to lighting requirements.

US Patent Application No. 20040155251 teaches a Peltier effect cooling device is formed in combination with an electronic device to form a unique thermal and electrical relationship. An electronic device to be cooled is placed in a serial electrical relationship between at least two thermoelectric couples while simultaneously being in thermal contact with a cold side of the cooler arrangement. The same current which, produces the thermoelectric effect in the Peltier thermocouples, also drives the electronic device. A balanced effect results as a higher driving current through the electronic device causes greater heating, it is offset by the added cooling due to a greater current in the thermocouples. In addition, a unique spatial arrangement provides improved heat distribution and transfer to a heat sink. Due to the unique shapes of Peltier elements, heat is pulled radially from a heat-generating source and distributed at a peripheral region. Shaped Peltier elements are tapered from a small cold area to a large hot area to further magnify the transfer of heat.

UK Patent Application No. GB2387025 teaches a light emitting apparatus comprises: a light source arrangement including a high power LED array (2) which is cooled by a cooling system. The cooling system comprises a heat conducting spreader layer in heat transfer relationship with the light source arrangement; a Peltier type thermoelectric cooler in heat transfer relationship with the heat spreader; and a heat pipe arrangement in heat transfer relationship with the thermoelectric cooler, the heat pipe arrangement including a distal condenser.

European Patent Specification No. EP1561071 teaches an invention that relates to Light Emitting Diode (LED) based lamps utilizing thermoelectric modules improving the efficiency of the lamps. The invention provides in a first aspect a light illuminating device that comprises at least one light emitting diode (LED), at least one thermoelectric module (TEM) having a first surface which is thermally connected to the LED, a heat sink thermally connected to a second surface of the at least one TEM, a thermally insulating cover creating a chamber substantially insulating the LED from ambient air. The LED may be of any conventional type, the invention however is particularly useful for devices using hi-flux LEDs, including traffic lights, illuminated roadway and/or emergency signs, airport runway lights and such.

European Patent Application No. EP1460695 teaches a base of LED includes a negative pole seat and a positive pole seat. The negative pole seat is made of conductive material with a flat negative pole plate at a lower outer side thereof, an integral negative pole body at an inner side thereof, multiple upright negative pole seat grooves at two lateral sides thereof and a negative pole recess at the top thereof respectively. The positive pole seat also is made of conductive material with a flat positive pole plate at the lower outer side thereof, an integral positive pole body at the inner side thereof, multiple seat grooves extending upright from the bottom at two lateral sides thereof. A crystal grain is located at the negative pole recess and a connecting wire at both ends thereof joined to the positive pole seat and the crystal grain and the negative pole plate and the positive pole plate are adhered to circuit of a circuit board to form a close circuit.

None of the prior art teaches the recycling of heat produced by a light source such as an LED where a thermoelectric module converts the heat to electricity, which is then feed into a parallel circuit with a device where the device includes but is not limited to the LED or a cooling device.

### SUMMARY OF THE INVENTION

An article of manufacture, comprising: a light source having heat as a by-product, light source includes but not limited to LED, OLED, LASER, thermally coupled with one or more thermoelectric modules; and an electrical feedback circuit that directs current generated by the thermoelectric modules to at least one device (charger for emergency power backup battery pack, sensors, monitoring device, control system, etc), or alternatively to the light source to reduce the light source's power consumption.

It is an object of the invention to capture thermal energy generated by any light source and turn the thermal energy into electricity, which may be cycled back to power the light source or other devices.

It is a further object of the invention to improve the efficiency of a light source by converting thermal energy into electricity and using a feedback circuit to help power the light source.

It is also an object of the invention to convert thermal energy into electricity and use the electricity to power other devices.

### BRIEF DESCRIPTION OF THE DRAWINGS

FIG. 1 shows the invention in a side view where the LED 200 sits on the thermoelectric module 400.

FIG. 2 shows an alternate embodiment of the invention in a side view where the LED 200 secured on the LED casing 600 and sits on the heat sink 500 and is surrounded by thermoelectric module 400.

FIG. 3 shows a schematic diagram of the electrical components that may be used in this invention.

FIG. 4 shows the invention in a top view where the LED 200 sits on the thermoelectric module 400.

### DESCRIPTION OF THE PREFERRED EMBODIMENTS

The preferred embodiments of the present invention will now be described with reference to the drawings. Identical elements in the various figures are identified with the same reference numerals.

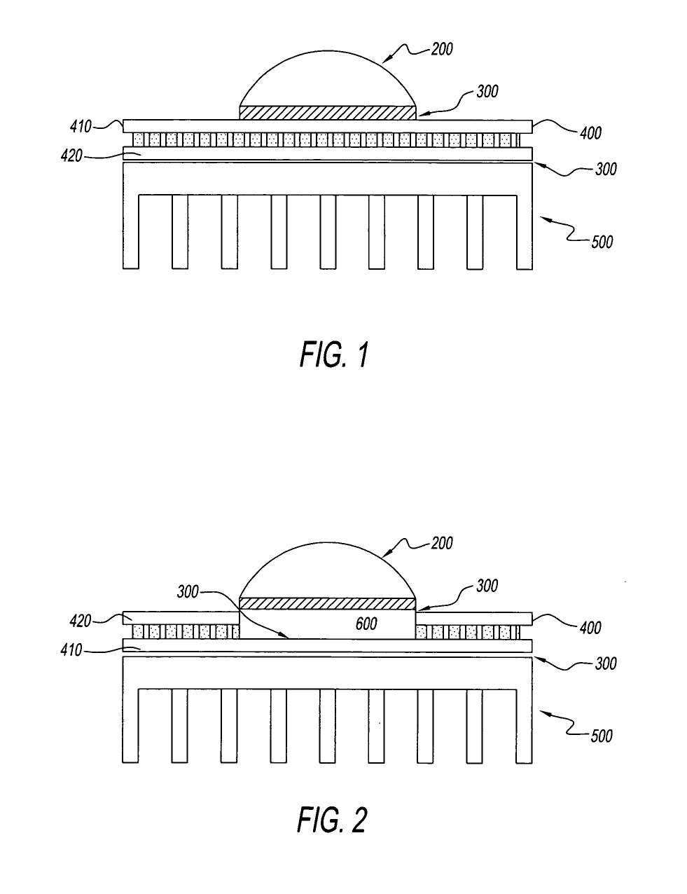

FIG. 1 shows the invention in a side view where the LED 200 sits on the thermoelectric module 400. For the purpose of this disclosure the term “LED” includes any light source or light producing device such as, but not limited an LED, an incandescent light source, or a fluorescent light source. The invention is shown with LED 200, thermal adhesive 300, thermoelectric module 400 and heat sink 500. The thermoelectric module 400 is shown with a hot side 410 and a cold side 420. The LED 200 acts as a heat source is shown affixed to the thermoelectric module 400 by thermal adhesive 300 at the hot side 410, transferring thermal energy from the LED 200 to the thermoelectric module 400. The thermoelectric module 400 is shown affixed to the heat sink 500 at the cold side 420, transferring thermal energy from the thermoelectric module 400 to the heat sink 500.

The thermoelectric module of the present invention is an electric generator that creates power from heat by relying on the Seebeck Effect. The Seebeck Effect is the creation of an electrical potential across points in a semiconductor that are at different temperatures. The effect is caused by the thermal energy of the valence electrons in the warmer part of the semiconductor; the kinetic energy of these electrons, which are very free in semiconductor, allows them to migrate toward the colder part more readily than the colder electrons migrate to the warmer part. The colder part of the semiconductor is therefore more negatively charged than the warmer part, resulting in electric potential. One thermoelectric module useful for the present invention Nextreme TEG, available from Nextreme Thermal Solutions, Inc. Durham, N.C. The present invention is capable of producing heat as a byproduct, which is then recovered to generate an electric current. Since some of the heat is lost, the present invention does require an external supply of electric current to operate continuously. Nonetheless, the capability of capturing some of the heat to regenerate electricity creates an energy efficient lighting system, since this current can now be reused to power the light source 200 or another device.

While the drawings show a single LED and thermoelectric module, a single thermoelectric module could be larger in size and have a plurality of LEDs disposed thereon.

The heat source for the thermoelectric module is a light source. The types of light sources include but are not limited to: LEDs, organic LED (OLED), polymer LED (PLED), LASER, LASER diodes, incandescent or florescent lighting elements. Types of LEDs especially useful for the invention are high power LEDs, (HPLED) which have an output of greater than 1 watt, and can be driven at more than 350 milliamperes of current.

In other embodiments, the LED source may be a miniature LED having a size between 2 to 15 mm. They could be low current to high current and low to high output, typically rated for 2 to 30 mA at 2 to 5V.

Other types of suitable LEDs include organic light-emitting diodes (OLEDs). If the emitting layer material of the LED is an organic compound, it is known as an Organic Light Emitting Diode (OLED). To function as a semiconductor, the organic emitting material must have conjugated pi bonds. The emitting material can be a small organic molecule in a crystalline phase, or a polymer.

LEDs have very low dynamic resistance, with the same voltage drop for widely varying currents. Consequently they cannot connect directly to normal voltage power sources. In some cases power supply voltage varies widely (as with batteries), causing large changes in LED current and light output. Because the voltage versus current characteristics of an LED are much like any diode (that is, current approximately an exponential function of voltage), a small voltage change results in a huge change in current. This can result either in an unlit LED or a current above the maximum ratings potentially destroying the LED. For such applications, a constant current regulator is commonly used as resistor control.

The LED may be attached to the thermoelectric module with a thermal adhesive. The thermal adhesive preferably produces a stable, durable, high-impact bond, with good heat transfer characteristics. The thermal adhesive can be a one or two-part adhesive and should develop strong, durable, high impact bonds at room temperature, which preferably improves heat transfer while maintaining electrical insulation. One potential adhesive is Ther-O-Bond 1600.

FIG. 1 also shows heat sink 500. Since LEDs by their nature generate large amounts of heat, a heat sink may be desirable in some applications. The heat sinks should be made with a good thermal conductor such as copper or aluminum alloy. Aluminum heat sinks can be easily formed by extrusion, thus making complex cross-sections possible. The heat sink's contact surface (the base) must be flat and smooth to ensure the best thermal contact with the object needing cooling. Thermally conductive grease may also be used in combination with the thermal adhesive or other securing means between the components discussed herein to ensure optimal thermal contact; such grease usually contains ceramic materials such as beryllium oxide and aluminum nitride, but may alternatively contain finely divided metal particles, e.g. colloidal silver. Further, a clamping mechanism, screws, or thermal adhesive could also hold the components of the present invention together.

FIG. 2 shows the invention in a side view where the LED 200 sits on LED casing 600. The invention is shown with LED 200, thermal adhesive 300, thermoelectric module 400, heat sink 500 and LED casing 600. The thermoelectric module 400 is shown with a hot side 410 and a cold side 420. The LED 200 is shown affixed to the LED casing 600 by thermal adhesive 300 providing thermal energy transfer from the LED 200 to the LED casing 600. The LED casing 600 is shown affixed to the heat sink 500 by thermal adhesive 300 providing thermal energy transfer from the LED casing 600 to the heat sink 500. The thermoelectric module 400 is shown disposed on the heat sink 500 by thermal adhesive 300 at the hot side 410. The LED casing should be a high heat conductive material, such as aluminum or an aluminum alloy.

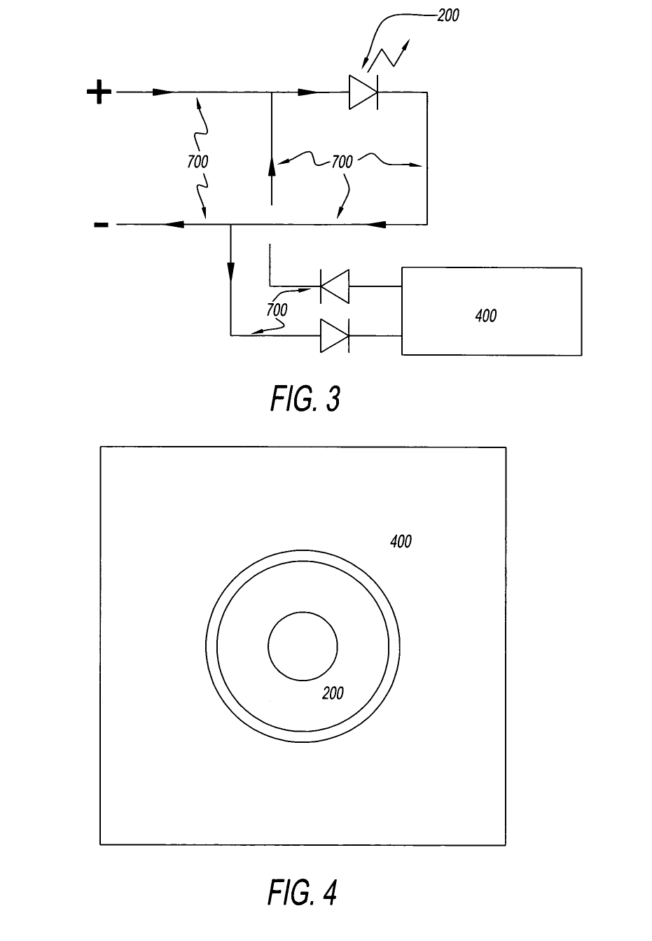

FIG. 3 shows a schematic diagram of the electrical components that may be used in this invention. The diagram is comprised of an LED 200, a thermoelectric module 400 and a feedback circuit. 700. A parallel circuit, the feedback circuit 700, is shown connecting the LED 200 and the thermoelectric module 400. While the feedback circuit is shown circulating electricity back into the LED, and thereby improving its efficiency, the current generated by the thermoelectric module could feed into other circuits or systems or other devices. For example, current may be directed to an electronic circuit powering devices such as, but not limited to, monitoring systems, sensors, or control systems. The current may also be utilized to charge a battery system, for example an emergency battery backup.

FIG. 4 shows the invention in a top view where the LED 200 sits on the thermoelectric module 400. The LED 200 is shown disposed on the thermoelectric module 400.

The invention is an article of manufacture consisting of: an LED 200 in thermal communication with a thermoelectric module 400; and a feedback circuit 700 that directs current generated by the thermoelectric module 400 to at least one device. Types of LED include but are not limited to: ordinary LEDs, polymer LEDs and organic LEDs. In the preferred embodiment the device may include but is not limited to the LED 200 or a cooling device for the LED 200 including but not limited to a cooling fan. Types of thermoelectric modules 400 include but are not limited to: single-stage, multi-stage, and Seebeck. In the preferred embodiment the thermoelectric module 400 may be disposed on the heat sink 500. In the preferred embodiment the thermoelectric module 400 may be disposed on the heat sink 500 with thermal adhesive 300. In the preferred embodiment the LED 200 may be affixed to the thermoelectric module 400 with thermal adhesive 300. The thermoelectric module 400 has a hot side 410 and a cold side 420. The hot side 410 may be in thermal communication with the heat sink 500 or may be in thermal communication with the LED 200. Thermal communication between the LED 200 and the thermoelectric module 400 or between the heat sink 500 and the thermoelectric module 400 may be achieved via thermal adhesive 300. The LED 200 may rest on a casing. Materials for the casing include but are not limited to: metal, plastics or composites all with a high specific heat capacity.

The invention recycles some of the heat energy produced by the LED. The thermoelectric module takes some of the heat produced by the LED and converts it into electricity. That electricity may then be used to either power the LED, and/or a cooling device or other device such as, but not limited to fans, control circuits such as sensors, microprocessors, and communication with other devices. The production of electricity reduces the demand for electricity from an external source. Since the thermoelectric module 400 will convert some of the heat into electricity the heat sink 500 will have less heat to dissipate, the heat sink may be smaller then otherwise would be required.

Although this invention has been described with a certain degree of particularity, it is to be understood that the present disclosure has been made only by way of illustration and that numerous changes in the details of construction and arrangement of parts may be resorted to without departing from the spirit and the scope of the invention.

We claim:

1. An article of manufacture, comprising:
a light source in thermal communication with a thermoelectric module; and
a feedback circuit that directs current generated by the thermoelectric module to at least one device.

2. The article of claim 1, wherein said light source is selected from a group comprising an LED an incandescent light source, or a fluorescent light source.

3. The article of claim 1, wherein the light source is affixed to the thermoelectric module with thermal adhesive.

4. The article of claim 1, wherein the thermoelectric module has a hot side and a cold side, and the hot side is in thermal communication with a heat sink.

5. The article of claim 2, wherein the thermoelectric module has a hot side and a cold side, and the hot side is in thermal communication with the light source.

6. The article of claim 1, wherein the thermoelectric module is disposed on a heat sink.

7. The article of claim 3, wherein the thermoelectric module is disposed on a heat sink with thermal adhesive.

8. The article of claim 1, wherein the thermoelectric module is a single-stage thermoelectric module.

9. The article of claim 1, wherein the thermoelectric module is a multi-stage thermoelectric module.

10. The article of claim 8, wherein said light source rests on a casing of high specific heat capacity.

11. The article of claim 2, wherein the other device is a cooling device said light source.

12. The article of claim 1, wherein the feedback circuit directs electricity to said light source, thereby improving the efficiency of said light source.

13. The article of claim 1, wherein the feedback circuit directs electricity to a battery charter for an emergency backup battery pack system.

14. The article of claim 1, wherein the feedback circuit directs electricity to an electronic circuit for monitoring system, sensors, or control systems.

15. An article of claim 1, wherein said article is capable of producing heat as a byproduct, and wherein said article is capable of recovering said byproduct for generation of electricity.

16. An article of claim 1, wherein said article is an energy efficient lighting system.
